(19) United States
(12) Patent Application Publication
(10) Pub. No.: US 2013/0090098 A1
(43) Pub. Date: Apr. 11, 2013

(54) SYSTEMS AND METHODS FOR DIALING INTO INTERACTIVE VOICE SYSTEMS WITH MINIMAL USER INTERACTION

(71) Applicant: Arvind Gidwani, San Diego, CA (US)

(72) Inventor: Arvind Gidwani, San Diego, CA (US)

(21) Appl. No.: 13/648,917

(22) Filed: Oct. 10, 2012

Related U.S. Application Data
(60) Provisional application No. 61/545,202, filed on Oct. 10, 2011.

(51) Int. Cl. H04W 4/00

(52) U.S. Cl. 455/414.1

(57) ABSTRACT

This disclosure relates generally to automating user actions relating to calendar events using mobile computing devices. More specifically, but not exclusively, the disclosure relates to systems, methods, and computer program products for dialing into interactive voice systems with minimal user interaction.

### CROSS REFERENCE TO RELATED APPLICATION

This application is related by common inventorship to, and claims priority to U.S. application Ser. No. 61/545,202 of Oct. 10, 2012 by Arvind Gidwani, entitled “Method and Apparatus for Auto Dialing from Meeting Calendar by Minimizing User Action/Commands on Mobile Devices”, the contents of which are hereby incorporated by reference herein in their entirety for all purposes.

### FIELD OF THE DISCLOSURE

This disclosure relates generally to automating to minimize user actions relating to calendar events using mobile computing devices. More specifically, but not exclusively, the disclosure relates to systems, methods, and computer program products for dialing into interactive voice systems with minimal user interaction.

### BACKGROUND OF THE DISCLOSURE

Manual input of call-in information such as phone numbers, meeting identifiers and passcodes may lead to inaccurate inputs by a user, and increase risk of accidents where a user attempts to input the call-in information while driving. Moreover, certain inefficiencies are realized where a user must access call-in information via one mobile or any computing application, and enter the call-in information in another application. Accordingly, what is needed are systems, methods and computer/mobile or any program products which may work on any computing device to automate some or all user inputs.

### SUMMARY OF THE DISCLOSURE

In accordance with the disclosure, systems, methods and computer program products comprising a computer usable medium having a computer readable program code embodied therein that is adapted to be executed to implement a method for dialing into interactive voice systems with minimal user interaction are described.

For example, aspects of this disclosure relate to: detecting, from a first electronic file specifying details regarding a scheduled meeting, first data representing a telephone number associated with the scheduled meeting, second data representing a meeting identifier or a passcode associated with the scheduled meeting, third data representing a date associated with the scheduled meeting, and fourth data representing a time associated with the scheduled meeting; causing the first data, the second data, the third data, and the fourth data to be stored in a storage medium; comparing the stored third data to a current date to determine if the stored third data matches the current date; comparing, when the stored third data matches the current date, the stored fourth data to a current time to determine if the current time is within a predefined time period from the time associated with the scheduled meeting as represented by the fourth data; and performing, when the current time is within the predefined time period from the time associated with the scheduled meeting as represented by the fourth data, a dialing process configured to initiate a call using the first data and the second data.

The detecting may relate to: matching the first data to one or more predefined first parameters specifying recognized phone number formats; matching the second data to one or more predefined second parameters specifying recognized meeting identifier or passcode formats; matching the third data to one or more predefined third parameters specifying recognized date formats; and matching the fourth data to one or more predefined fourth parameters specifying recognized time formats. The detecting may further relate to: identifying the first, second, third and fourth parameters based on an identification of a creator of the first electronic file.

The performing a dialing process may relate to: causing a user interface to display a user-selectable option to initiate a call or by automated call without user interaction using the stored first data and the stored second data; detecting a selection by the user of the user-selectable option; generating one or more dialing signals based on the stored first data and the stored second data; causing a transceiver to output the one or more dialing signals to the voice response system; and detecting one or more responses from the voice response system indicating that the one or more dialing signals were received. It is to be understood that other systems beyond voice response systems are contemplated, including data systems, systems that produce beeps, data security exchange triggering events of inputting meeting IDs, etc.

The generating one or more dialing signals may relate to: determining a user's location; identifying a first phone number from among two or more phone numbers specified by the first data based on the user's location, wherein the first phone number includes an area code associated with the user's location; and generating the one or more dialing signals based on the first phone number.

Various additional aspects, features, and functions are described below in conjunction with the appended Drawings.

### BRIEF DESCRIPTION OF THE DRAWINGS

The present application may be more fully appreciated in connection with the following detailed description taken in conjunction with the accompanying drawings.

FIG. 1 shows a block diagram depicting a calendaring system for facilitating calendar event creation and management with minimal user input.

FIG. 2 illustrates a process flow diagram detailing a process for receiving, creating or updating information associated with calendar events, and carrying out operations associated with those events.

FIG. 3 illustrates a process flow diagram detailing steps associated with a user interface on a mobile device.

### DETAILED DESCRIPTION OF THE DISCLOSURE

Various aspects of the invention are described below. It should be apparent that the teachings herein may be embodied in a wide variety of forms and that any specific structure, function, or both, being disclosed herein is merely representative. Based on the teachings herein one skilled in the art should appreciate that any aspect disclosed may be implemented independently of any other aspects and that two or more of these aspects may be combined in various ways. For example, a system may be implemented or a method may be practiced using any number of the aspects set forth herein.

The disclosure relates generally to systems, methods and computer program products for minimizing user actions required to create ,track and connect calendared events, and to implement actions based on those calendar events. As described herein, user commands may be click, touch, audio, speech, or other user input known in the art. Shortcut commands may be used to execute predefined steps designed to ease calendar data entry, prevent errors, and implement actions based on those calendar entries. may be

Generally, a calendaring system in accordance with various aspects of this disclosure may acquire and store information regarding calendar events. Moreover, the system may extract calendar event information obtained from various sources, including email, mail clients like Outlook, manual inputs by users, and other sources. Extracted data may be used to create notifications, establish a conference call link with minimal user interaction, or perform other functions. As an example, the conference call link notification can be communicated to another device to perform the desired action defined in link.

### Example System(s)

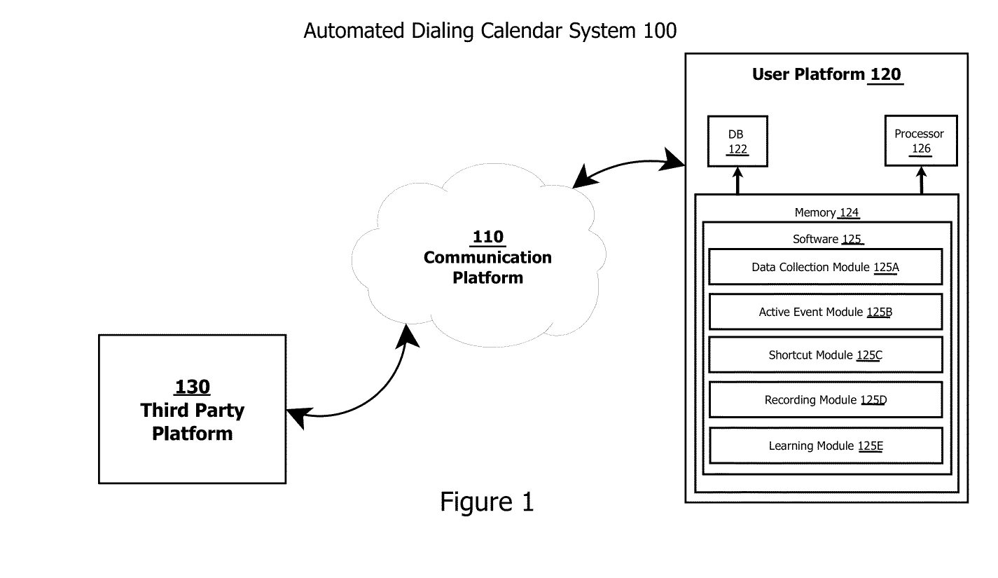

Attention is now drawn to FIG. 1, which depicts an automated dialing calendar system 100 that may be configured to include a communication platform 110, a user platform 120, a management platform 130, and a third party platform 140. The term “platform” as used herein may refer to a single component, a grouping of remote components at multiple locations, or a centralized grouping of components at a single location. A platform may include components that may be hosted by, or services that may be offered by parties other than those directly associated with each platform. A platform may further include hardware, software, or other solutions and other components configured to exchange and process data and instructions using various protocols across various network communication pathways. Certain aspects of each platform may be described in more detail below; however, the description herein may be not intended to be limiting, and alternative embodiments may be contemplated as understood by one of skill in the art.

### Communication Platform 110

The communication platform 110 may be configured to provide communication links among the various platforms 120-150 (and others not shown, but otherwise contemplated). For example, the communication platform 110 may utilize any one or a combination of known communication networks and connections to facilitate communication in the content enrichment system 100, including the Internet, private networks, local area networks, cellular or other over-the-air wireless carrier interfaces, Bluetooth, Wi-Fi, and other wired and wireless communication pathways. Any communication network may be utilized alone or in combination to provide connectivity for the content enrichment system 100.

### User Platform 120

The user platform 120 may be configured to operate on a suitable computing device operated by a user. For example, such a user-operated device may be any of numerous general purpose or special purpose computing system environments or configurations. Examples of well-known computing devices, systems, environments, and/or configurations thereof that may be suitable for use in accordance with particular embodiments of the disclosure include, but are limited to, personal computers, hand-held or laptop devices, mobile phones, tablet and e-readers, and programmable consumer electronics. The user platform 120 may include various components, including a display, a database 122, memory 124 from which software may be executed, a processor 126, a camera, an input/output interface (e.g., a touch screen, keyboard, mouse), and other components. The user platform 120 may also include various software applications, including those that operate in conjunction with a web browser (e.g., through a LAN connection or radio link), and those that operate without web connectivity. As shown in FIG. 1. the user device platform 130 may include a database or other storage component 122. The database 122 may be referred to herein as a hard disk drive for convenience, but this is not required, and one of ordinary skill in the art will recognize that other storage media may be utilized without departing from the scope of the invention. In addition, one of ordinary skill in the art will recognize that the database 122 which is depicted as a single storage device, may be realized by multiple (e.g., distributed) storage devices. The database 122 may store data in a file format, such as XML, comma separated values, tab separated values, or fixed or variable length fields. The database 132 may receive, store and send, among other data, data related to one or more calendar events.

As further shown in FIG. 1, the management platform 130 may comprise a software solution 125 with various modules implemented in software, including: 125: (i) a data collection module 125A; (ii) active events module 125B; (iii) a shortcut module 125C; (iv) a recording module 125D; and (iv) a learning module 125E.

The processor 126 may be configured to execute instructions embodied in the software solution 125 stored on the memory 124. One of ordinary skill in the art will recognize that alternative embodiments, which implement one or more components of the invention in hardware, are within the scope of the disclosure.

Attention is now drawn to modules 125A-E of the software solution 125. Modules 125A-E may operate in concert with each other to perform certain functions of the software solution 125, as described herein.

### Data Collection Module 125A

The data collection module 125A may be configured to receive input for a user or another source regarding an event—e.g., input such as date and time of event, phone number, event identifier, passcode, attendees and associated contact information, name of the event, requirements for the event, a user's notes about the event (e.g., to prepare presentation materials or questions). Once input is received, the data collection module 125A may analyze and store some or all of the information for later use.

In one aspect of the disclosure, the data collection module 125A may be initiated automatically upon detection of some condition. For example, the data collection module 125A may identify text in an email that is recognized to be associated with a possible event. Once the text is recognized, the data collection modules 125A may extract information from that email or from the user to create an event reminder or to store the information for later use in automating certain user activities associated with the event.

The data collection module 125A may be configured to identify keywords or number combinations in order to extract event data from emails or other files. For example, a user may receive an email on the user platform 120 listing an event name, a date and time of an event, a phone number associated with the event, a meeting identifiers, and other data associated with the event. The system may detect and distinguish valid phone numbers in 7-digit, 10-digit, and international formats. Other information, such as meeting identifiers may be determined based on known formats of existing teleconference protocols used by WebEx, Meeting Maker, Outlook, Live Meeting, Smart Meeting, and others. The data collection module 125A may also distinguish between different phone numbers for the same event (e.g., (e.g., local, international, regional), where a particular phone number related to the user's current or future location may be prioritized for use. In this manner, the user's location, as detected by known location-based technologies, may be correlated with a country code, area code, or other information to determine the best phone number for the user at any time.

### Active Event Module 125E

The active event module 125B may be configured to track active calendar events and initiate actions regarding the event and user preferences. Once event data is extracted, control of the actions related to the event may be managed by the active event module 125B. For example, event data for each event may be accessed and edited by a user, or otherwise updated using received updates from other sources. Additionally, the active event module 125A may control the execution of automated actions such as event setup, call in, reminders, alarms and event sharing. By way of example, a user may input a preferred date and time for a meeting, and the active event module 125B may send an invitation to other users, who may suggest other times for the meeting. The active event module 125B may then automatically update the date and time based on the user's calendar where the user's calendar indicates that the other times are available.

Data associated with each calendar event may be stored in a local database, server, cloud storage, or other networked storage system. For example, the data may be stored in a table database. Data fields in the database may include meeting identifier, passcode, call numbers, contacts, address, and other information related to each event. A user may also create new data fields for additional data like notes and other fields particular to a user. The user may also add tags to distinguish meeting types or to simplify automated detection. Keywords for particular fields, when compared with tags, may be utilized by the active event module to further distinguish meeting types that may require different automated input and calendar event creation.

### Shortcut Module 125C

The shortcut module 125C may be configured to provide quick commands or macros for completing repetitive or tedious tasks related to events. Generally, the shortcut module 125C executes predefined actions with minimal user input required (e.g., one click, finger swipe, voice command). The user may create a large number of shortcuts which are unique and provide an efficient solution to error-prone user input. Alternatively, the software 125 may provide shortcuts without user intervention in creating the shortcuts.

The shortcut module 125C may also be implemented to quickly initiate a conference call. For example, the shortcut module 125C may attempt to establish a communication link automatically with limited user intervention by generating signals associated with dial-in numbers and meeting identifiers that would otherwise be entered manually by a user.

### Recording Module 125D

The recording module 125D may be configured to record the entirety or portions of teleconferences for review by a user at a later time. Recorded information may be stored in either audio or text format. For audio recordings, the recording module may be configured to provide easy selection and editing of meeting segments. For instance, in a situation where an entire meeting may be recorded but only the second hour of the meeting may be provided to a party for review, a user may easily trim, edit, and group the audio recordings of a meeting according to subject, recipient, or other parameters. Furthermore, the recording module 125D may be configured to detect which user may be speaking based on call in number, user identifier, voice recognitions, or otherwise. A text to speech algorithm may be utilized by the recording module so that an audio recording of a meeting may be transcribed into text and presented as a transcript for users. Thus, after a teleconference in completed, a text version may be automatically sent (e.g., using a mobile phone, email, file export feature) to all contacts and associated users of a calendar event. This feature may be especially useful when certain people are unable to attend a meeting but wish to know the details of what has been discussed. The recorded transcripts may be stored locally, on a secure server, or elsewhere, and may be easily communicated to other users using network pathways.

The data collection module 125A may also analyze the text to determine whether another meeting time was discussed, and then prompt a user to set up a meeting for that time.

### Learning Module 125E

The learning module 125E may be configured to periodically update calendar events based on gathered information from related and template calendar events. Similar events that commonly share information may be tracked, and updated information may be stored in association with calendar events. In one embodiment, the learning module 125E may generate a confirmation message explaining the suggested learning for user feedback. Common tasks may be automatically generated into shortcuts to provide quick and efficient access.

For example, in a particular embodiment of the disclosure a user may utilize protocols that require meeting identifiers and passcodes which vary in length. Moreover, a particular user may choose passcodes of various lengths for other reasons such as providing more robust security. The learning module 125D may be configured to detect the variances of meeting identifiers and may prompt user input to confirm potential meeting identifiers as detected by the software 125. Once a particular meeting identifier and passcode format has been saved, any future meeting identifiers or passcodes matching the format may be automatically detected without user intervention. The determination may also be determined by user preference or detection of a particular teleconference protocol.

In another embodiment, the learning module 125E may learn keywords with which to associate calendar event data. Keywords, such as phone, call, meeting, teleconference, meeting, etc. may be detected and used to generate the creation of a new calendar event. Furthermore, the keywords may be automatically tracked and learned to improve association and accuracy in creating automated calendar events. Essentially, the frequency of the keywords associated with any calendar event may be tracked and analyzed to increase detection accuracy and distinguish between different types of meetings (e.g., different clients, offices, protocols, etc.). The learning module 125E may also track which user created the calendar event, and then use formats associated with that user.

Additionally, a user may create a customized format of teleconference information. A meeting notice which may be sent in a repetitive format may be input by a user to automatically generate a calendar event. For example, a user may provide (e.g., via SMS, email or other communication technology) notices to meeting contacts in the format: “[Meeting identifier]: [Meeting Title]-[Subject]-[Notes]-[Call in numbers]-[Passcode]-[Other contacts].” The learning module 125E may be configured to detect this format and generate a particular calendar event. Calendar events of different types may be generated using distinguishable information formats.

### Third Party Platform 130

The third party platform 130 may include a number of systems that interact with any of the other platforms. The third party platform 130 may, for example, host telephone calls that are accessible by telephone numbers specified in calendar invites. The third party platform 130 may alsogenerate calendar invites.

### Example Process(es)

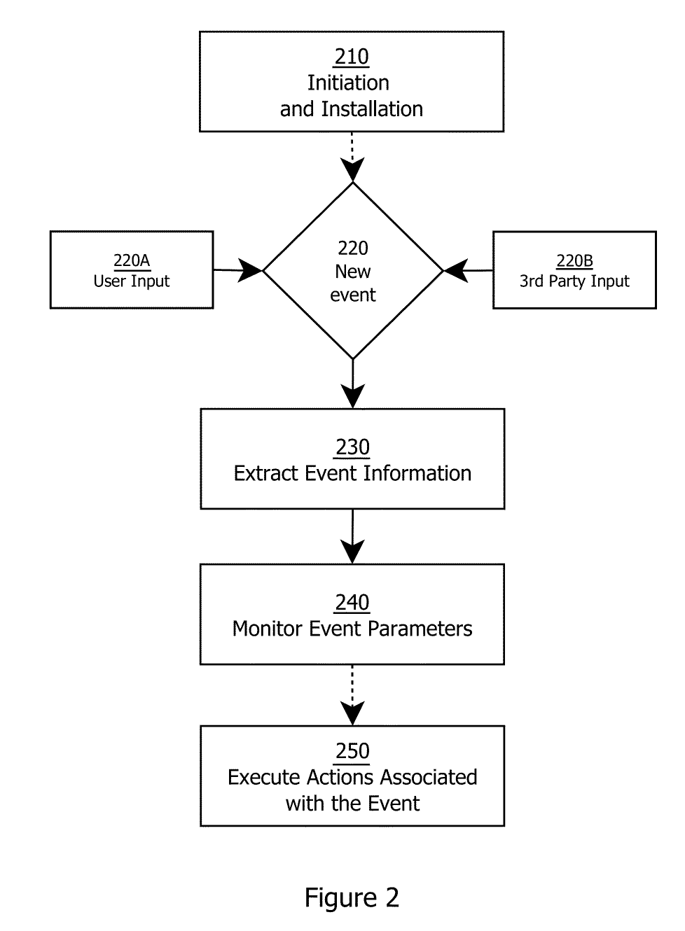

Attention may be now drawn to FIG. 2, which illustrates a high-level process flow diagram associated with certain aspects of the invention.

At step 210, the user installs or initiates a calendaring program. User platforms 120 like mobile computing devices, for example, may require download and installation of an application program on the user platform 120. After installation, a user may use the user platform 120 to choose a username, password and other registration information (e.g., name, phone number, address). Furthermore, preliminary setup may be executed to sync the user platform 120 with other content sources like email services at the third party platforms 130. The setup process may also be automated so that a user may begin using the program quickly without cumbersome setup and initiation.

At step 220, a new or previously created calendaring event may be identified. At step 220A, a user may create a new calendaring event, or at step 220B, a calendar event may be received by the third party platform 130 (e.g., in the form of a calendar invite received via a mail client operating on the user platform 120, or in the form of information from an email or other content source that is determined to relate to an event). At step 220A, for example, a user may initiate creation of a new event by inputting event information as needed, including date, time, location, phone number, meeting identifier, passcode, etc. Some information may be provided automatically according to predetermined settings and history.

At step 230, information from the event is extracted and stored in a database. Extracted information may include a phone number, meeting identifier, passcode, date and time of the event, and other information. Depending on the source of the information, the program may detect the information for extraction based on recognizing keywords (e.g., “Call-in number”, “passcode”, etc.) and then storing the numbers that follow or are otherwise associated with those keywords. Alternatively, the program may detect the actual numbers using predefined formats relating to the type of number (e.g., phone number is ten digits, separated by hyphen, encased by parentheses, etc.; e.g., meeting identifier passcode are 6 to 12 digits).

Once extracted, the information may be stored in a suitable storage means, and arranged in a suitable format (e.g., a table). Once stored, the extracted information may be updated where a change is detected (e.g., when an updated calendar invite or other updated information is detected). Updates may be used to modify stored information about the event, or to add more information about the event. The stored information may also be displayed to a user, and may be used to update a user's personal records (e.g., contacts, etc.)

At step 240, certain parameters of stored event information are compared to current conditions. For example, the extracted date and time are compared the current date and time to determine, based on predefined rules, if a reminder is provided to a user of the user platform 120, if a prompt is provided asking the user to initiate a phone call based on the extracted phone number, meeting identifier, and/or passcode, or if another operation is needed. The predefined rules may be set by the user (e.g., provide reminder 10 minutes before the meeting time on the date of the meeting, etc.)

If the current conditions dictate, based on the predefined rules, that some operation is necessary, then the user platform 120 executes that operation at step 250.

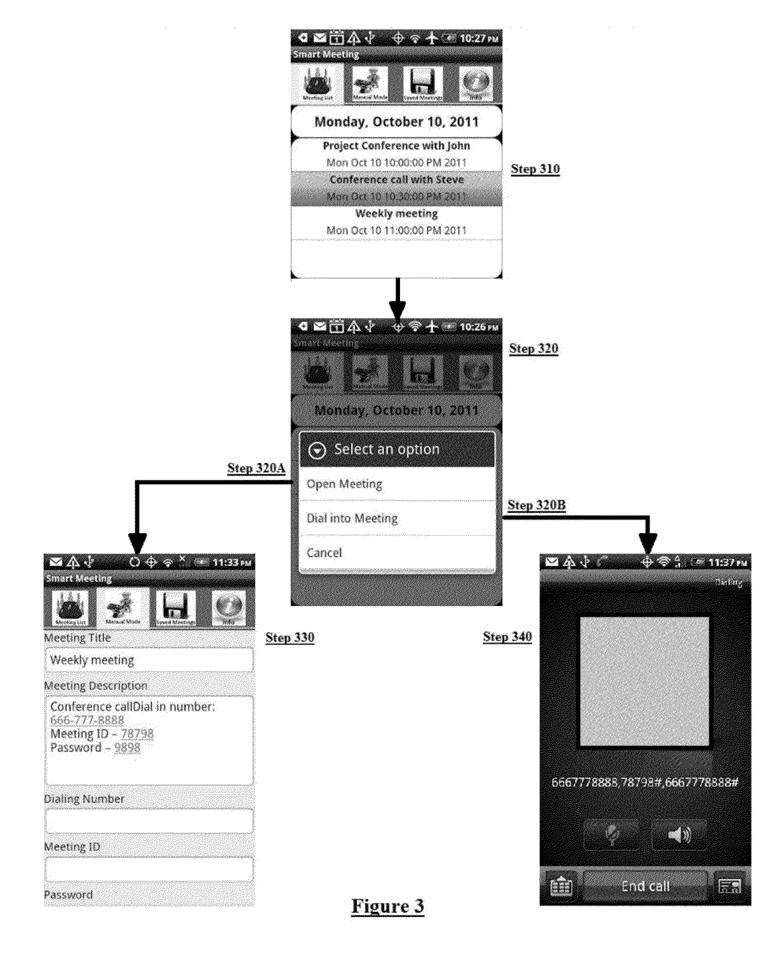

Attention may be now drawn to FIG. 3, which illustrates a particular process flow detailing a process for managing and executing an automated calendar event on a mobile phone. At step 310, one or more calendar events may be listed for a user to select. Selection may occur via touchscreen impression, speech recognition/commands, or other methods for executing a selection. New events which have been automatically detected through, email clients, email content, online sources, and other sources may be shown to the user along with events that the user created. Listed events may be sorted (e.g., by date/time, priority/type, subject, attendees, or any other calendar event data. At step 320, a user may select a particular event, and then be provided a list regarding options (e.g., open the event file for more detail, dial into a meeting associated with the event, return to the list of events). At step 320A, the user may view and edit details of the event, or at 320B, the user may select an option to autodial the phone number, meeting identifier, and passcode without further user intervention. Automatic dialing into a call associated with an event may be accomplished in various ways depending on the interactive voice system that hosts the call associated with the event. For example, a phone number, meeting identifier, and passcode may be parsed by a character (e.g., #), and the application interacts with the interactive voice system to determine when the meeting identifier and the passcode must be sent (e.g., by listening for respective audio prompts associated with the meeting identifier and passcode after the phone number has been dialed and after any other inputs). Signals specifying the meeting identifier and the passcode may be provided in a particular order depending on the interactive voice system, for example, relating to WebEx, Meeting Maker, Outlook meetings, Live Meeting, Smart Meeting, or other systems.

In accordance with various aspects of the disclosure, systems, methods and computer program products comprising a computer usable medium having a computer readable program code embodied therein that is adapted to be executed to implement a method for dialing into interactive voice systems with minimal user interaction are contemplated.

For example, aspects of this disclosure relate to: detecting, from a first electronic file specifying details regarding a scheduled meeting, first data representing a telephone number associated with the scheduled meeting, second data representing a meeting identifier or a passcode associated with the scheduled meeting, third data representing a date associated with the scheduled meeting, and fourth data representing a time associated with the scheduled meeting; causing the first data, the second data, the third data, and the fourth data to be stored in a storage medium; comparing the stored third data to a current date to determine if the stored third data matches the current date; comparing, when the stored third data matches the current date, the stored fourth data to a current time to determine if the current time is within a predefined time period from the time associated with the scheduled meeting as represented by the fourth data; and performing, when the current time is within the predefined time period from the time associated with the scheduled meeting as represented by the fourth data, a dialing process configured to initiate a call using the first data and the second data.

The detecting may relate to: matching the first data to one or more predefined first parameters specifying recognized phone number formats; matching the second data to one or more predefined second parameters specifying recognized meeting identifier or passcode formats; matching the third data to one or more predefined third parameters specifying recognized date formats; and matching the fourth data to one or more predefined fourth parameters specifying recognized time formats. The detecting may further relate to: identifying the first, second, third and fourth parameters based on an identification of a creator of the first electronic file.

The performing a dialing process may relate to: causing a user interface to display a user-selectable option to initiate a call using the stored first data and the stored second data; detecting a selection by the user of the user-selectable option; generating one or more dialing signals based on the stored first data and the stored second data; causing a transceiver to output the one or more dialing signals to the voice response system; and detecting one or more responses from the voice response system indicating that the one or more dialing signals were received.

The generating one or more dialing signals may relate to: determining a user's location; identifying a first phone number from among two or more phone numbers specified by the first data based on the user's location, wherein the first phone number includes an area code associated with the user's location; and generating the one or more dialing signals based on the first phone number.

### Variations to Embodiments

It may be understood that the specific order components disclosed herein are examples of exemplary approaches. Based upon design preferences, it may be understood that the specific order components may be rearranged, and/or components may be omitted, while remaining within the scope of the present disclosure unless noted otherwise. The previous description of the disclosed embodiments may be provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure may be not intended to be limited to the embodiments shown herein but may be to be accorded the widest scope consistent with the principles and novel features disclosed herein.

The disclosure may be not intended to be limited to the aspects shown herein, but may be to be accorded the full scope consistent with the specification and drawings, wherein reference to an element in the singular may be not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” may be intended to cover: a; b; c; a and b; a and c; b and c; and a, b and c.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In accordance with certain aspects of the present disclosure, one or more of the process steps described herein may be stored in memory as computer program instructions. These instructions may be executed by a digital signal processor, an analog signal processor, and/or another processor, to perform the methods described herein. Further, the processor(s), the memory, the instructions stored therein, or a combination thereof may serve as a means for performing one or more of the method steps described herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality may be implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user terminal. In the alternative, the processor and the storage medium may reside as discrete components in a user terminal.

The previous description of the disclosed embodiments may be provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure may be not intended to be limited to the embodiments shown herein but may be to be accorded the widest scope consistent with the principles and novel features disclosed herein. It may be intended that the following claims and their equivalents define the scope of the disclosure.

Aspects of the present disclosure are typically carried out in or resident on a computing network. The computing network generally includes computer hardware components such as servers, monitors, I/O devices, network connection devices, as well as other associated hardware. In addition, the aspects and features described below may include one or more application programs configured to receive, convert, process, store, retrieve, transfer and/or export data and other content and information. As an example, these aspects and features may include one or more processors that may be coupled to a memory space comprising SRAM, DRAM, Flash and/or other physical memory devices. Memory space may be configured to store an operating system (OS), one or more application programs, such as a UI program, data associated with the pertinent aspect or feature, applications running on processors in the device, user information, or other data or content. The various aspects and features of the present disclosure may further include one or more User I/O interfaces, such as keypads, touch screen inputs, mice, Bluetooth devices or other I/O devices. In addition, the certain aspects and features may include a cellular or other over the air wireless carrier interface, as well as a network interface that may be configured to communicate via a LAN or wireless LAN (WiLAN), such as a Wi-Fi network. Other interfaces, such as USB or other wired interfaces may also be included.

As used herein, computer program products comprising computer-readable media including all forms of computer-readable medium except, to the extent that such media may be deemed to be non-statutory, transitory propagating signals.

While various embodiments of the present disclosure have been described in detail, it may be apparent to those skilled in the art that the present disclosure can be embodied in various other forms not specifically described herein.

What is claimed is:

1. A computer-implemented method for automating dial-in procedures to an interactive voice response system using a computing device, the method comprising:
detecting, from a first electronic file specifying details regarding a scheduled meeting, first data representing a telephone number associated with the scheduled meeting, second data representing a meeting identifier or a passcode associated with the scheduled meeting, third data representing a date associated with the scheduled meeting, and fourth data representing a time associated with the scheduled meeting;
causing the first data, the second data, the third data, and the fourth data to be stored in a storage medium;
comparing the stored third data to a current date to determine if the stored third data matches the current date;
comparing, when the stored third data matches the current date, the stored fourth data to a current time to determine if the current time is within a predefined time period from the time associated with the scheduled meeting as represented by the fourth data; and
performing, when the current time is within the predefined time period from the time associated with the scheduled meeting as represented by the fourth data, a dialing process configured to initiate a call using the first data and the second data.

2. The computer-implemented method of claim 1, wherein the detecting comprises:
matching the first data to one or more predefined first parameters specifying recognized phone number formats;
matching the second data to one or more predefined second parameters specifying recognized meeting identifier or passcode formats;
matching the third data to one or more predefined third parameters specifying recognized date formats; and
matching the fourth data to one or more predefined fourth parameters specifying recognized time formats.

3. The computer-implemented method of claim 1, wherein the performing a dialing process comprises:
causing a user interface to display a user-selectable option to initiate a call using the stored first data and the stored second data;
detecting a selection by the user of the user-selectable option;
generating one or more dialing signals based on the stored first data and the stored second data;
causing a transceiver to output the one or more dialing signals to the voice response system; and
detecting one or more responses from the voice response system indicating that the one or more dialing signals were received.

4. The computer-implemented method of claim 2, wherein the detecting comprises:
identifying the first, second, third and fourth parameters based on an identification of a creator of the first electronic file.

5. The computer-implemented method of claim 3, wherein the generating one or more dialing signals comprises:
determining a user's location;
identifying a first phone number from among two or more phone numbers specified by the first data based on the user's location, wherein the first phone number includes an area code associated with the user's location; and
generating the one or more dialing signals based on the first phone number.

6. A system for automating dial-in procedures to an interactive voice response system, the system comprising a processor operable to:
detect, from a first electronic file specifying details regarding a scheduled meeting, first data representing a telephone number associated with the scheduled meeting, second data representing a meeting identifier or a passcode associated with the scheduled meeting, third data representing a date associated with the scheduled meeting, and fourth data representing a time associated with the scheduled meeting;
cause the first data, the second data, the third data, and the fourth data to be stored in a storage medium;
compare the stored third data to a current date to determine if the stored third data matches the current date;
compare, when the stored third data matches the current date, the stored fourth data to a current time to determine if the current time is within a predefined time period from the time associated with the scheduled meeting as represented by the fourth data; and
perform, when the current time is within the predefined time period from the time associated with the scheduled meeting as represented by the fourth data, a dialing process configured to initiate a call using the first data and the second data.

7. The computer-implemented method of claim 6, wherein the detecting comprises:
matching the first data to one or more predefined first parameters specifying recognized phone number formats;
matching the second data to one or more predefined second parameters specifying recognized meeting identifier or passcode formats;
matching the third data to one or more predefined third parameters specifying recognized date formats;
matching the fourth data to one or more predefined fourth parameters specifying recognized time formats; and
identifying the first, second, third and fourth parameters based on an identification of a creator of the first electronic file.

8. The computer-implemented method of claim 6, wherein the performing a dialing process comprises:
causing a user interface to display a user-selectable option to initiate a call using the stored first data and the stored second data;
detecting a selection by the user of the user-selectable option;
determining a user's location;
identifying a first phone number from among two or more phone numbers specified by the stored first data based on the user's location, wherein the first phone number includes an area code associated with the user's location; and
generating one or more dialing signals based on the first phone number and the stored second data;
causing a transceiver to output the one or more dialing signals to the voice response system; and
detecting one or more responses from the voice response system indicating that the one or more dialing signals were received.

9. A computer program product comprising a computer usable medium having a computer readable program code embodied therein, said computer readable program code adapted to be executed to implement a method for automating dial-in procedures to an interactive voice response system, the method comprising:
detecting, from a first electronic file specifying details regarding a scheduled meeting, first data representing a telephone number associated with the scheduled meeting, second data representing a meeting identifier or a passcode associated with the scheduled meeting, third data representing a date associated with the scheduled meeting, and fourth data representing a time associated with the scheduled meeting;
causing the first data, the second data, the third data, and the fourth data to be stored in a storage medium;
comparing the stored third data to a current date to determine if the stored third data matches the current date;
comparing, when the stored third data matches the current date, the stored fourth data to a current time to determine if the current time is within a predefined time period from the time associated with the scheduled meeting as represented by the fourth data; and
performing, when the current time is within the predefined time period from the time associated with the scheduled meeting as represented by the fourth data, a dialing process configured to initiate a call using the first data and the second data.

10. The computer-implemented method of claim 11, wherein the detecting comprises:
matching the first data to one or more predefined first parameters specifying recognized phone number formats;
matching the second data to one or more predefined second parameters specifying recognized meeting identifier or passcode formats;
matching the third data to one or more predefined third parameters specifying recognized date formats;
matching the fourth data to one or more predefined fourth parameters specifying recognized time formats; and wherein the performing a dialing process comprises;
identifying the first, second, third and fourth parameters based on an identification of a creator of the first electronic file;
causing a user interface to display a user-selectable option to initiate a call using the stored first data and the stored second data;
detecting a selection by the user of the user-selectable option; determining a user's location;
identifying a first phone number from among two or more phone numbers specified by the stored first data based on the user's location, wherein the first phone number includes an area code associated with the user's location; and
generating one or more dialing signals based on the first phone number and the stored second data;
causing a transceiver to output the one or more dialing signals to the voice response system; and
detecting one or more responses from the voice response system indicating that the one or more dialing signals were received.
